(19) United States
(12) Patent Application Publication
(10) Pub. No.: US 2010/0224407 A1
(43) Pub. Date: Sep. 9, 2010

(54) Observation Port or Membrane to Assist the Proper Positioning of a Cable Accessory on a Cable

(76) Inventors: David Charles Hughes, Rubicon, WI (US); David Matthew Frisch, Watertown, WI (US); Henry Gordon Fuller, Oconomowoc, WI (US)

Correspondence Address: KING & SPALDING, LLP, 1100 LOUISIANA ST., STE. 4000, ATTN.: IP Docketing, HOUSTON, TX, 77002-5213, US

(21) Appl. No.: 12/398,224

(22) Filed: Mar. 5, 2009

(51) Int. Cl. H01R 4/00

(52) U.S. Cl. 174/84 R

(57) ABSTRACT

A splice comprising a hollow receptacle housing with a first connector end and a second connector end, where a first observation port is in the first end and a second observation port is in the second end. The splice covers the exposed sections of two cables and the device that electrically couples the cables together. The device is placed in the proper position by the user looking for the transition between a semi-conductive layer and an insulating layer of the cables though each observation port. When the appearance of the transition between the insulating layer and the semi-conductive layer in the first observation port mirror that in the second observation port, the splice is properly positioned.

### RELATED APPLICATION

This Application is related to U.S. patent application Ser. No. ______ [Attorney Docket No. 13682.117402 (RTC-028415 U2)] entitled “Method of Using an Observation Port or Membrane to Assist the Proper Positioning of a Cable Accessory on a Cable” filed Mar. 5, 2009. The complete disclosure of the above-identified related application is hereby fully incorporated herein by reference.

### TECHNICAL FIELD

The disclosed apparatus relates generally to connectors between electrical cables. Specifically, this application relates to technology that allows cables to be spliced together with a splice of minimal length while maintaining the proper positioning between components.

### BACKGROUND

A routine task faced by utility linepersons is the need to connect two cables that do not possess some form of mutually compatible connector device. Typically, the utility lineperson removes sections of the outer semi-conductive layer and the inner insulating layer of the cable to expose the electrical conductor of both cables. The electrical conductors of both cables are then electrically coupled. Once the electrical conductors are electrically coupled, the utility lineperson now has to protect the exposed electrical conductors in a manner that is consistent with the remaining sections of the outer semi-conductive layer and inner insulating layer. The covering used to replicate the semi-conductive layer and the insulating layer is referred to as a splice.

Conventional pre-molded splices have operated by inserting the first cable through the splice, causing the exposed end of the cable to project out of the opposite end of the splice. The two cables are then electrically coupled. The splice is then slid over the electrical coupling to protect the electrical coupling from the external environment. Additionally, as the splice is slid over the electrical coupling, a semiconductive insert in the splice is positioned around the electrical coupling, which creates a Faraday cage around the coupling. The Faraday cage maintains the electrical potential on all sides of any air 313 between or around the coupled components to prevent a partial discharge therein.

Two factors that influenced the length of the splice were the length of the splice to effectively seal the electrical coupling and create a proper Faraday cage verses the minimization of length of the splice to facilitate installation of the splice. These two competing interests can impact the effectiveness of a splice. If the splice is too long, then installation becomes difficult as more of the splice has to pass over the first cable. If the splice is too short, then the electrical coupling or the insulation is exposed, or internal conductive portions of the splice are not properly positioned to electrically shield the coupled conductors of the cables, thereby leading to potential electrical arcing. If the splice is at the optimum size, it may still prove ineffective if not properly centered and covering the cables. Previous attempts to reconcile these issues used rolled splices, but those connectors can introduce foreign contamination to the electrical connection.

One conventional method for attempting to properly center a splice over electrically coupled cables is to make the entire walls of the splice relatively thin. With a thin-walled splice, the positioning of the cables within the splice can be detected based on visual deformations of the shell caused by the contact with the cables therein. However, a thin-walled splice has several deficiencies. For example, a thin-walled splice is more likely to tear or split when being installed over the cables, which usually involves stretching the splice over the cables. Additionally, a thin-walled splice is more likely to tear along the parting lines of a mold during the manufacturing process, thereby creating additional scrap material. A thin-walled splice also may be damaged by a fault current such that the splice fails to conduct a fault current to ground. In this case, the damaged splice does not allow “fault reinitiation,” and a utility lineperson may be injured by touching the energized splice (or nearby components).

Therefore, a need exists in the art for a splice that is positionable over the cables and the electrical connector with a minimal length to ease installation and with sufficient thickness to avoid the deficiencies of conventional splices, while still maintaining proper positioning of the splice with regard to the spliced cables.

### SUMMARY

The disclosed apparatus relates generally to electrical connections. More particularly, the disclosed apparatus relates to a device that allows a connection between two physically separate cables in a manner that allows electrical coupling and external protection for the electrical coupling.

According to one exemplary aspect, a splice comprises a hollow receptacle housing with a first end and a second end, where a first observation port is disposed in the first end and a second observation port is disposed in the second end. The observation ports aid the user in positioning of the cables in the splice by allowing the user to observe the transition between the semi-conductive layer and the insulating layer of cables when coupled via the splice.

According to another exemplary aspect, two cables are connected using the splice. Each cable is prepared by removing a section of the semi-conductive outer layer and the insulating inner layer to expose the electrical conductor of the cable. The splice is coupled to a first cable in a preparatory position and the two conductors are coupled together. Once the conductors are coupled together, the splice is placed in a cover position where the appearance of the cables in the first observation port and the second observation port mirror each other, showing their respective semi-conductive and insulating layers of the respective cables.

These and other aspects, objects, features, and embodiments of the invention will become apparent to those skilled in the art upon consideration of the following detailed description of illustrated embodiments exemplifying the best mode for carrying out the apparatus as presently perceived.

### BRIEF DESCRIPTION OF THE DRAWINGS

The invention may be better understood by reading the following description of non-limitative, exemplary embodiments with reference to the attached drawings, wherein like parts of each of the figures are identified by the same reference character, and which are briefly described as follows.

FIG. 1 is a perspective view of a splice with observation ports coupled to two cables according to an exemplary embodiment.

FIG. 2 is a perspective view of the splice of FIG. 1.

FIG. 3 comprises FIGS. 3A-3D. FIG. 3A is a perspective view of a first cable and a second cable before splice installation according to an exemplary embodiment.

FIG. 3B is a perspective view of the first cable and the second cable with a splice installed over the first cable in a preparatory position according to an exemplary embodiment.

FIG. 3C is a perspective view of the first cable and the second cable electrically coupled by an electrical coupling device with the splice installed over the first cable in the preparatory position according to an exemplary embodiment.

FIG. 3D is a cutaway view of the first cable and the second cable electrically coupled by an electrical coupling device with the splice in a cover position and installed over the first cable, the second cable, and the electrical coupling device according to an exemplary embodiment.

FIG. 4 comprises FIGS. 4A-4D. FIG. 4A is a top perspective view of the connector end of the splice illustrating an observation port or membrane according to an exemplary embodiment without a cable installed.

FIG. 4B is a cross sectional view of the connector end of the splice according to the exemplary embodiment of FIG. 4A.

FIG. 4C is a top perspective view of the connector end of the splice with a cable installed therein according to an exemplary embodiment.

FIG. 4D is a cross-sectional view of the connector end of the splice according to the exemplary embodiment of FIG. 4C.

FIG. 5 comprises FIGS. 5A-5D. FIG. 5A is a top perspective view of the connector end of the splice illustrating an observation port or membrane according to an exemplary edge embodiment without a cable installed.

FIG. 5B is a cross sectional view of the connector end of the splice according to the exemplary embodiment of FIG. 5A.

FIG. 5C is a top perspective view of the connector end of the splice according to the exemplary edge embodiment with a cable installed therein.

FIG. 5D is a cross-sectional view of the connector end of the splice according to the exemplary embodiment of FIG. 5C.

### DETAILED DESCRIPTION OF THE INVENTION

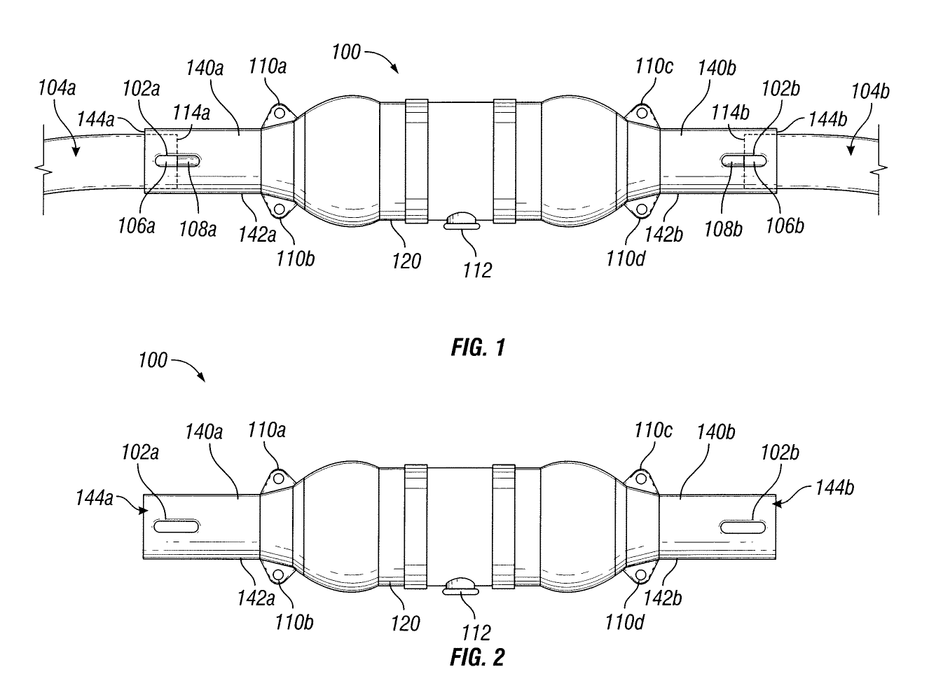

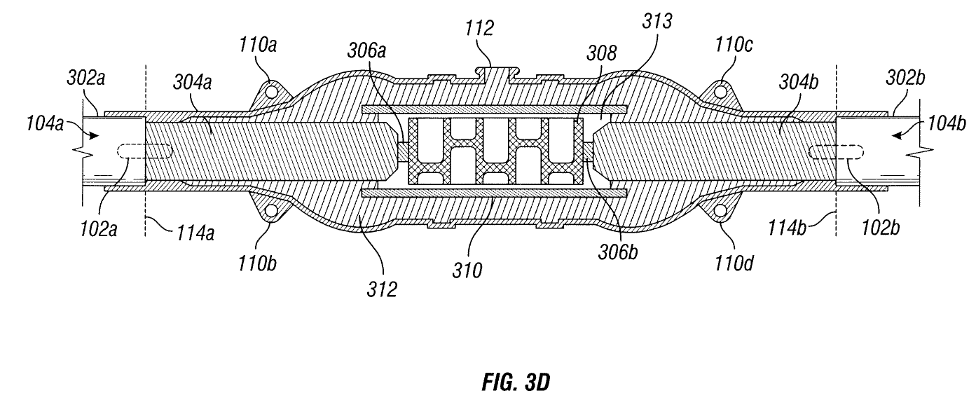

FIG. 1 is a perspective view of a splice with observation ports 102a-b coupled to two cables 104a-b according to an exemplary embodiment. The splice 100 couples two cables 104a-b that are otherwise uncoupled. The connection may be made for any reason, including but not limited to extension of a preexisting electrical cable or for repair of a damaged cable. The splice 100 is long enough to electrically shield air 313 (FIG. 3) inside the connector to prevent any voltage drop across the air 313 and to shield the coupled cables when properly centered.

The splice 100 comprises a semi-conductive main body 120 acting as an outer shell with a first cross sectional area with two connector ends 140a-b having a smaller, second cross sectional area than that of the main body 120. As used throughout this specification, a “semi-conductive” material can refer to rubber or any other type of material that carries current, and thus can include conductive materials. The main body 120 comprises a fill sprue 112 via which insulation 312 (FIG. 3) is injected into the main body 120 during the manufacturing process. The proximal sections 142a-b of the connector ends are coupled to the main body 120, with the distal sections 144a-b projecting away from the main body 120. Attached near the junction of the main body 120 and a proximal sections 142a-b of the connector ends 140 are drain wire tabs 110a-d that may be used to couple the main body 120 to ground.

Observation ports 102a-b are located in the connector ends 140a-b of the splice 100. The observation ports 102a-b are located near the distal ends 144a-b of the connector ends 140a-b in an exemplary embodiment. In an exemplary embodiment, the observation ports 102a-b are translucent, allowing a user to perceive the opposite side of the observation port 102a-b. In alternative exemplary embodiments, the observation ports 102a-b can be a hole through the outer conductive layer of the splice 100, thereby allowing a user to see through the observation ports 102a-b, or the observation ports 102a-b can be a thin membrane, thereby allowing the user to perceive a change in the layers of materials of a cable contained with the splice 100. The observation ports 102a-b facilitate the centering function of the splice 100. As shown in FIG. 1, the observation ports 102a-b show a semi-conductive section 106a-b of the cables 104a-b on the side of the cables 104a-b and an insulating section 108a-b of the cables on the side of the main body 120 of the splice 100. The transition between the semi-conductive section 106a-b in the observation ports 102a-b and the insulating section 108a-b in the observation ports 102a-b aids in centering the splice 100, as will be discussed below.

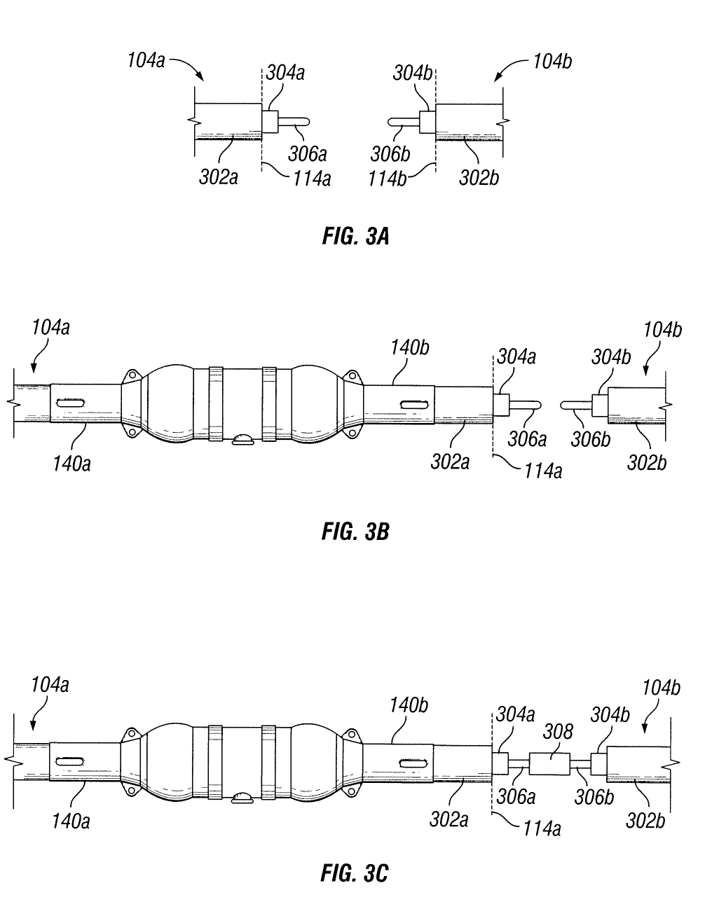

FIG. 2 is a perspective view of the splice 100 of FIG. 1. In the illustrated embodiment, without the cables 104a-b installed in the splice 100, the observation ports 102a-b have a uniform appearance.

The method of splicing cables involves placing a splice 100 on a first cable 104a, electrically coupling the first cable 104a and a second cable 104b using an electrical coupling device, and positioning the splice 100 such that the splice 100 covers the electrical coupling device and the coupled conductors of the cables 104a-b.

FIG. 3 comprises FIGS. 3A-3D. FIG. 3A is a perspective view of a first cable 104a and a second cable 104b before the splice 100 is installed according to an exemplary embodiment. A portion of the semi-conductive outer layer 302a-b and a smaller portion of the insulating inner layer 304a-b are removed from the respective cables 104a-b, exposing the conductors 306a-b of each cable 104a-b. A visible transition 114a-b between the semi-conductive outer layer 302a-b and insulating inner layer 304a-b of the cables 104a-b. When the splice 100 is properly positioned on the cables 104a-b, the transition 114a-b is visible through the observation ports 102a-b as shown in FIG. 1.

FIG. 3B is a perspective view of the first cable 104a and the second cable 104b with the splice 100 installed over the first cable 104a in a preparatory position according to an exemplary embodiment. The end of the first cable 104a with the exposed conductor 306a is inserted into the first connector end 140a until the conductor 306a of the first cable 104a extends from the second connector end 140b of the splice 100.

FIG. 3C is a perspective view of the first cable 104a and the second cable 104b electrically coupled by an electrical coupling device 308 with the splice 100 installed over the first cable 104a in the preparatory position according to an exemplary embodiment. With the conductor 306a of the first cable 104a exposed through the splice 100, the conductor 306b of the second cable 104b is placed adjacent to the conductor 306a of the first cable 104a. The conductors 306a-b are then electrically coupled by the use of a splice connector, such as the electrical coupling device 308. Crimp connectors are one of several suitable types of electrical coupling device 308 for the cables 104a-b that may be utilized in the exemplary embodiment. With the cables 104a-b connected, the splice 100 is slid into position where the electrical coupling device 308 is enclosed by the splice 100 and the connector ends 140a-b of the splice 100 are placed over the semi-conducting outer layers 302a-b of both cables 104a-b, as shown in FIG. 3D.

FIG. 3D is a cutaway view of the first cable 104a and the second cable 104b electrically coupled by an electrical coupling device 308 with the splice 100 in a cover position and installed over the first cable 104a, the second cable 104b, and the electrical coupling device 308 according to an exemplary embodiment. The semi-conductive outer layer 302a-b of the respective cables 104a-b is partially positioned within the splice 100 to provide a protective barrier for the conductors 306a-b and the electrical coupling device 308. Furthermore, when properly positioned, an interior semi-conductive portion 310 of the splice 100 is positioned around the coupled conductors 306a-b and the ends of the insulating layers 304a-b to provide a Faraday cage around the connection. The splice 100 further comprises an insulating layer 312 disposed between the semi-conductive portion 310 and the semi-conductive main body 120, as illustrated in FIG. 3D.

To verify that the splice 100 is properly positioned (in other words, centered and/or having the Faraday cage created by the interior semi-conductive portion 310 located around the coupled conductors 306a-b and around both insulating layers 304a-b), the user observes the position of the transition 114a-b between the semi-conductive outer layers 302a-b and the insulating inner layers 304a-b through the observation ports 102a-b. When the splice 100 is properly positioned, the transition 114a-b between the semi-conductive outer layers 302a-b and the insulating inner layers 304a-b will become visible through the observation ports 102a-b. When the user positions the splice 100, the user can have the position of the transition 114a-b between the semi-conductive outer layer 302a and the insulating inner layer 304a in observation port 102a mirror the position of the semi-conductive outer layer 302b and the insulating inner layer 304b in observation port 102b. When the observation ports 102a-b mirror each other, the splice 100 is properly positioned in the exemplary embodiment.

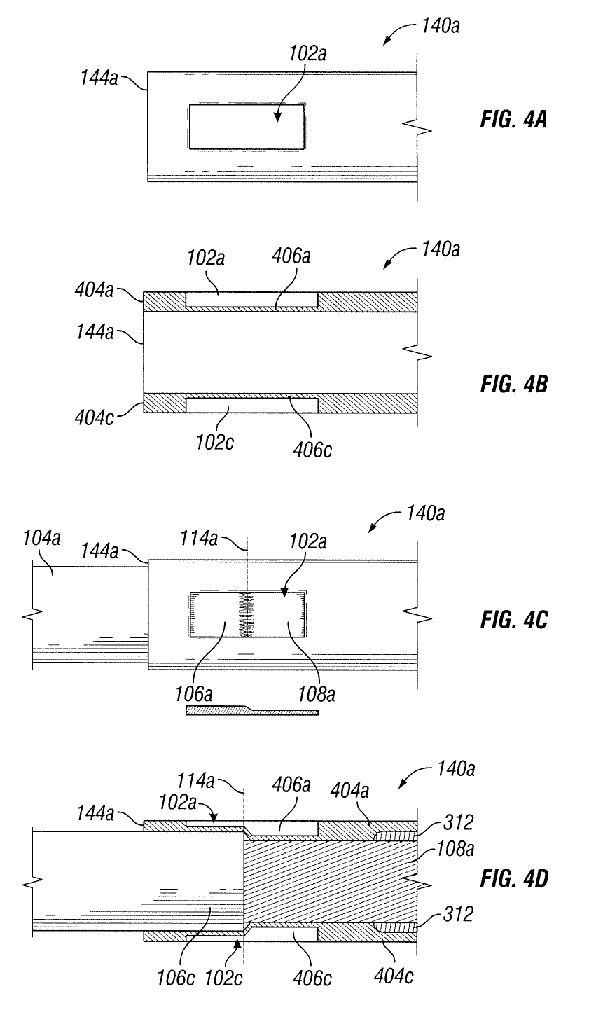

In an exemplary embodiment, the observation ports 102a-b comprise a membrane 406 (FIG. 4) that allows an observer to perceive cables under the membrane 406. In the exemplary embodiments, the membrane 406 is thick enough to prevent tearing, but thin enough to allow observation of the transition 114 in the splice 100 by touch or by sight. Examples in the exemplary embodiment are membranes 406 that are about 10% or 25% of the thickness of the shell 120, and others which are about 5-50% or 10-20% of the thickness of the shell 120. Other alternatives are suitable to provide both observation properties and maintaining the protective properties of the splice 100. In exemplary embodiments, the membrane 406 can comprise a thin layer of material, which material can be the same material as the main body 120, the same material as the insulating layer 312, or another suitable material. Additionally, the membrane 406 can comprise a translucent or transparent material that can allow direct visual confirmation of the positioning of the cables with respect to the observation ports 102a-b. In yet another exemplary embodiment, the observation ports 102a-b can be a hole within the end connectors 104a-b.

Two exemplary embodiments for positions of the observation ports 102a-b will be described. FIG. 4 comprises FIGS. 4A-4D. FIG. 4A is a top perspective view of the connector end 140a of the splice 100 according to an “adjacent” embodiment, without cable 104a installed. The previously described exemplary embodiments utilized the adjacent embodiment. The adjacent embodiment involves the observation ports 102 located near the distal ends 144a of the connector ends 140, but not in contact with the distal ends 144a of the connector ends 140.

FIG. 4B is a cross sectional view of the connector end 140 of the splice 100 according to the embodiment of FIG. 4A. The splice 100 has an end 404 of a uniform thickness and membranes 406a, 406c covering the observation ports 102a, 102c. The membranes 406a, 406c have a uniform thickness that is less than a thickness of the end 404 of the splice 100.

In the illustrated, exemplary embodiment, the connector end 140 has two observation ports 102a, 102c that facilitate observation from more than one direction. In the figures shown, observation ports 102a and 102c and membranes 406a and 406c are shown, with the understanding that observation ports 102b and 102d and membranes 406b and 406d are on the connector end 104b that is not shown.

FIG. 4C is a top perspective view of the connector end 140a of the splice 100 according to an adjacent embodiment with a cable 104a installed. FIG. 4D is a cross sectional view of the connector end 140a of the splice 100 according to the embodiment of FIG. 4C. The transition 114a between the semi-conductive layer 106a and the insulating layer 108a of the cable 104a is visible in the observation port 102a to indicate the splice 100 is properly positioned. Additionally, the transition 114a also is visible in the second observation port 102b. The thickness of the membranes 406a, 406c allows the transition 114a to be perceived in the observation ports 102a, 102c. For example, the transition can be visible or can be detected through touch.

The installed cable 104a pushes against the inner surface of the end connector 140a and the observation ports 102a, 102c, creating a seal that insulates the conductors 306a, 306c and the electrical coupling device 308 from the outside air. The displacement of the observation port 102 causes the thickness of the observation port 102 to adjust depending on where the cable 104a is installed.

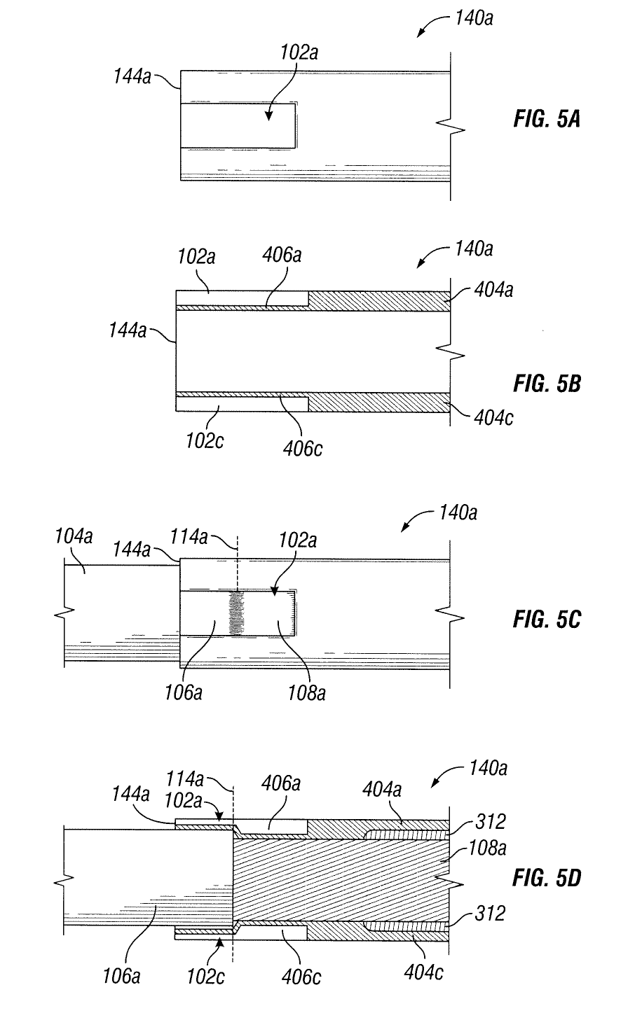

An alternative embodiment has the observation port 102a located on the edge of the splice 100. FIG. 5 comprises FIGS. 5A-5D. FIG. 5A is a top perspective view of the connector end 140a of the splice 100 according to an “edge” embodiment, without cable 104a installed. In the edge embodiment, the observation port 102a is located on a distal end 144a of the connector ends 140a. FIG. 5B is a cross sectional view of the connector end 140a of the splice 100 according to the embodiment of FIG. 5A. Except for the location of the observation port 102a (or 102c), the remaining components in FIGS. 5A-5D are the same as the components in FIGS. 4A-4D.

An observation port may be manufactured in a splice in any suitable manner. In one exemplary embodiment, a mold can include a boss that creates an area of lesser thickness in a side of the splice. In this case, the boss also provides an advantage of preventing or limiting deflection and movement of a mandrel within the main body 120 when the insulation layer 312 is injected therein during the molding process for manufacturing the splice. The area of lesser thickness is the observation port. In this embodiment, the observation port comprises the same material as the side of the splice. In an alternative exemplary embodiment in which the observation port is a hole in the splice, the mold can include solid components around which the splice is molded, thereby leaving a hole as the observation port. In yet another exemplary embodiment, a membrane material may be applied and press molded into the apertures in the splice, forming the membrane 406a (for example) from a material that is different from the material in the side of the splice. In this case, for example, the membrane may be made from an opaque material, a translucent material, or a transparent material.

Therefore, the disclosed apparatus is well adapted to attain the ends and advantages mentioned, as well as those that are inherent therein. The particular embodiments disclosed above are illustrative only, as the disclosed apparatus may be modified and practiced in different but equivalent manners apparent to those having ordinary skill in the art and having the benefit of the teachings herein. Having described some exemplary embodiments of the presently disclosed apparatus, various modifications are within the purview of those in the art without departing from the scope and spirit of the invention. While numerous changes may be made by those having ordinary skill in the art, such changes are encompassed within the spirit of the disclosed apparatus as defined by the appended claims. Furthermore, no limitations are intended to the details of construction or design herein shown, other than as described in the claims below. It is therefore evident that the particular exemplary embodiments disclosed above may be altered or modified and all such variations are considered within the scope and spirit of the present disclosed apparatus. The terms in the claims have their plain, ordinary meaning unless otherwise explicitly and clearly defined by the patentee.

What is claimed is:

1. An cable splice, comprising:
a tubular semi-conductive shell;
an insulating layer disposed within said shell; and
a first observation area disposed in said shell, said observation area allowing the determination of a position of a cable disposed within said connector.

2. The splice of claim 1, wherein said first observation area is disposed adjacent to a distal section of an end of said shell.

3. The splice of claim 1, further comprising a tubular semi-conductive inner layer disposed within said shell, wherein said insulating layer is disposed between said shell and said inner layer.

4. The splice of claim 1, wherein said first observation area comprises an aperture in said shell.

5. The splice of claim 1, wherein said shell comprises a first thickness, wherein said first observation area comprises a second thickness, and wherein the first thickness is greater than the second thickness.

6. The splice of claim 1, wherein said first observation area is integrally formed in said shell.

7. The splice of claim 1, wherein said first observation area is partially located in a distal section of an end of said shell.

8. The splice connecter of claim 1, further comprising a second observation area disposed in said shell.

9. The splice connecter of claim 8, wherein said first and second observation areas are located on opposite ends of said shell.

10. The splice connecter of claim 8, wherein said first and second observation areas are located on the same end of said shell.

11. An cable splice, comprising:
a semi-conductive shell, said shell comprising a depression having a thickness that is less than surrounding portions of said shell; and
an insulating layer disposed within said shell.

12. The splice of claim 11, wherein said depression is disposed adjacent to a distal section of an end of said shell.

13. The splice of claim 11, wherein said depression comprises an aperture in said shell.

14. The splice of claim 11, wherein said depression is integrally formed in said shell.

15. The splice of claim 11, wherein said depression is partially located in a distal section of an end of said shell.

16. A cable splice connecter system, comprising:
a first cable and a second cable that each comprise
an outer semi-conductive layer,
an inner insulating layer enclosed within said outer semi-conductive layer, and
a conductor enclosed within said inner insulating layer; wherein said first cable has at least a portion a first semi-conductive layer removed and a smaller portion of a first insulating layer removed to expose a first conductor, and
wherein said second cable has at least a portion second semi-conductive layer removed and a smaller portion of a second insulating layer removed to expose a second conductor;
a splice, comprising
a tubular semi-conductive shell,
an insulating layer disposed within said shell, and
a first observation port disposed in said shell,
wherein said first cable is partially disposed in a first end of said shell such that said semi-conductive shell of said splice contacts said semi-conductive layer of said first cable, said insulating layer of said splice contacts said insulating layer of said first cable, and said first observation port is positioned over a transition between said semi-conductive layer of said first cable and said insulating layer of said first cable, and
wherein said second cable is partially disposed in a second end of said shell such that said semi-conductive shell of said splice contacts said semi-conductive layer of said second cable and said insulating layer of said splice contacts said insulating layer of said second cable.

17. The system of claim 16, wherein the transition between said semi-conductive layer of said first cable and said insulating layer of said first cable is observable through said first observation port.

18. The system of claim 16, further comprising a splice connector that couples the first conductor and the second conductor together.

19. The system of claim 16, wherein said splice further comprises a tubular semi-conductive inner layer disposed within said shell of said splice, wherein said insulating layer of said shell is disposed between said shell of said splice and said inner layer of said splice, wherein said inner layer of said splice surrounds said first and second conductors that are exposed when a portion of said first insulating layer of said first cable is removed and a portion of said second insulating layer of said second cable is removed, respectively, and wherein said inner layer of said shell surrounds a portion of said first insulating layer of said first cable and a portion of said second insulating layer of said second cable.

20. The system of claim 16, wherein said splice comprises a second observation port disposed in said shell and positioned over a transition between said semi-conductive layer of said second cable and said insulating layer of second first cable.

21. The system of claim 20, wherein the transition between said semi-conductive layer of said first cable and said insulating layer of said first cable is observable through said first observation port, and
wherein the transition between said semi-conductive layer of said second cable and said insulating layer of said second cable is observable through said second observation port.

22. The system of claim 21, wherein said splice is properly positioned on said first and second cables when the transition between said first semi-conductive layer and said insulating layer of said first cable that is observable through the first observation port mirrors the transition between the second semi-conductive layer and the second insulating layer of said second cable that is observable through the second observation port.

23. The system of claim 16, wherein said first observation port and said second observation port comprise a translucent membrane.

24. The system of claim 16, wherein said first observation port comprises a lesser thickness than an end portion of said shell.
